(19) United States
(12) Patent Application Publication
(10) Pub. No.: US 2020/0379330 A1
(43) Pub. Date: Dec. 3, 2020

(54) LIGHT INTEGRATION ROD AND PROJECTION DEVICE

(71) Applicant: Coretronic Corporation, Hsin-Chu (TW)

(72) Inventors: HUNG-YU LIN, Hsin-Chu (TW); CHUN-HSIN LU, Hsin-Chu (TW); CHUN-LI CHEN, Hsin-Chu (TW)

(21) Appl. No.: 16/884,079

(22) Filed: May 27, 2020

(30) Foreign Application Priority Data
May 31, 2019 (CN) 201920808022.9

(51) Int. Cl. G03B 21/20

(52) U.S. Cl. CPC G03B 21/208; G03B 21/2066

(57) ABSTRACT

A light integration rod has a light incident end and a light emitting end opposite to each other. A normal vector of a light emitting cross section of the light emitting end is non-parallel to a light emitting direction of the light integration rod. The invention further provides a projection device having the light integration rod. The light integration rod and the projection device provided by the invention can reduce the defocus phenomenon of the light on the light valve, thereby improving the light utilization efficiency.

### CROSS-REFERENCE TO RELATED APPLICATION

This application claims the priority benefit of China application serial no. CN201920808022.9, filed on May 31, 2019. The entirety of the above-mentioned patent application is hereby incorporated by reference herein and made a part of this specification.

### FIELD OF THE INVENTION

The invention relates to a projection device, and more particularly to a projection device including a light integration rod.

### BACKGROUND OF THE INVENTION

In the known projection device, a light integration rod is often disposed between the light source and the light valve to uniformize the illumination beam provided by the light source. The uniformity of the illumination beam irradiating on the light valve is achieved by adjusting the total length of the light integration rod or the area at the light emitting end of the light integration rod. The conventional light valve uses binary tilt pixel (BTP) technology to control the rotation angle of the light valve, and the light receiving angle is 24 degrees. The new projection device uses the tilt and roll pixel (TRP) technology to control the rotation angle of the light valve. The TRP technology can make the light receiving angle of the light valve be 34 degrees, which has a larger rotation angle than the traditional BTP technology. The light receiving efficiency can be greatly improved under the conditions of the same illumination beam.

However, increasing the light receiving angle of the light valve causes the incident angle of the illumination beam irradiating on the light valve to become larger, that is, the optical path difference between the paths from each region of the light valve (for example, the inner region and the edge region) to the focal plane becomes larger. For example, in the current illumination system design, only the central focus (inner region) can be focused on the correct position. The illumination beam irradiating on the edge region of the light valve is an out-of-focus beam away from the focal plane, so that the illumination beam cannot be focused on each region of the light valve. This causes the edge of the light spot of the illumination beam irradiating on the light valve to blur and reduces the brightness uniformity of the light spot. Furthermore, when the illumination beams having the optical path difference are converted by the light valve into an image beam and then the image beam is projected through the projection lens onto the screen to form an image, the defocusing phenomenon, which causes blur image, may occur at the edge of the image, or the brightness at the edge of the image may be reduced. In the conventional method, the area of the light emitting end of the light integration rod is increased for improvement, which ensuring that the uniform region of the light spot is larger than the working region of the light valve, so that the defocused region of the edge of the light spot falls outside the working region of the light valve. Therefore, a large part of the illumination beam irradiates on the non-working region of the light valve, which causes to additional light (energy) loss. Or the optical elements are increased to overcome the focus imbalance, which result in the disadvantages such as increasing cost and the inability to reduce the size of the illumination system of the projection device.

The information disclosed in this “BACKGROUND OF THE INVENTION” section is only for enhancement understanding of the background of the invention and therefore it may contain information that does not form the prior art that is already known to a person of ordinary skill in the art. Furthermore, the information disclosed in this “BACKGROUND OF THE INVENTION” section does not mean that one or more problems to be solved by one or more embodiments of the invention were acknowledged by a person of ordinary skill in the art.

### SUMMARY OF THE INVENTION

The invention provides a light integration rod, which can improve the light utilization efficiency.

The invention provides a projection device, which can improve the light utilization efficiency.

Other advantages and objects of the invention may be further illustrated by the technical features broadly embodied and described as follows.

In order to achieve one or a portion of or all of the objects or other objects, an embodiment of the invention provides a light integration rod, which has a light incident end and a light emitting end opposite to each other. A normal vector of a light emitting cross section of the light emitting end is non-parallel to a light emitting direction of the light integration rod.

In order to achieve one or a portion of or all of the objects or other objects, an embodiment of the invention provides a projection device, which includes an illumination system, a light guiding element, a light valve and a projection lens. The illumination system includes a light source and the aforementioned light integration rod. The light source is used to provide an illumination beam passing through the light integration rod. The light guiding element is disposed on a transmission path of the illumination beam and is used to receive the illumination beam from the light integration rod. The light valve is disposed on the transmission path of the illumination beam and is used to receive the illumination beam from the light guiding element and convert the illumination beam into an image beam. The projection lens is disposed on a transmission path of the image beam and is used to project the image beam out of the projection device.

In the light integration rod of the invention, the illumination beam is adjusted to enter the focal plane of the light valve by making the normal vector of the light emitting cross section of the light emitting end non-parallel to the light emitting direction of the light integration rod, so that the focal plane is closer to each region of the light valve, thereby reducing the defocusing phenomenon at the edge of the light spot, wherein the light emitting direction of the light integration rod can be the optical axis direction or the main light traveling direction of the light integration rod. Comparing with the conventional method of enlarging the end of the light integration rod to enlarge the illumination area of the illumination beam irradiating on the light valve and overcome the disadvantage of defocusing phenomenon, the light integration rod of the invention does not need to enlarge the illumination area of the illumination beam irradiating on the light valve and makes the illumination beam be focused more on the light valve without causing additional light loss. Therefore, the light utilization efficiency can be improved. Since the projection device of the invention uses the aforementioned light integration rod, the light utilization efficiency can also be improved.

Other objectives, features and advantages of The invention will be further understood from the further technological features disclosed by the embodiments of The invention wherein there are shown and described preferred embodiments of this invention, simply by way of illustration of modes best suited to carry out the invention.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic diagram of a projection device according to an embodiment of the invention;

FIG. 2 is a schematic pictorial view of a light integration rod according to an embodiment of the invention;

FIG. 3 is a schematic view of the light integration rod in the X-Z plane in FIG. 2;

FIG. 4 is a schematic diagram of beam paths of an illumination beam according to an embodiment of the invention;

FIG. 5A is a schematic view of a light spot on a light valve when a conventional light integration rod is used;

FIG. 5B is a schematic view of a light spot on a light valve when the light integration rod of an embodiment is used; and

FIG. 5C is a schematic comparison diagram of the energy distributions at the edge of the light spot on the light valve of using the conventional light integration rod and the light integration rod of an embodiment.

### DETAILED DESCRIPTION OF PREFERRED EMBODIMENTS

In the following detailed description of the preferred embodiments, reference is made to the accompanying drawings which form a part hereof, and in which is shown by way of illustration specific embodiments in which the invention may be practiced. In this regard, directional terminology, such as “top”, “bottom”, “front”, “back”, etc., is used with reference to the orientation of the Figure(s) being described. The components of the invention can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the invention. Also, it is to be understood that the phraseology and terminology used herein are for the purpose of description and should not be regarded as limiting. The use of “including”, “comprising”, or “having” and variations thereof herein is meant to encompass the items listed thereafter and equivalents thereof as well as additional items. Unless limited otherwise, the terms “connected”, “coupled”, and “mounted” and variations thereof herein are used broadly and encompass direct and indirect connections, couplings, and mountings. Similarly, the terms “facing”, “faces”, and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component facing “B” component directly or one or more additional components is between “A” component and “B” component. Also, the description of “A” component “adjacent to” “B” component herein may contain the situations that “A” component is directly “adjacent to” “B” component or one or more additional components is between “A” component and “B” component. Accordingly, the drawings and descriptions will be regarded as illustrative in nature and not as restrictive.

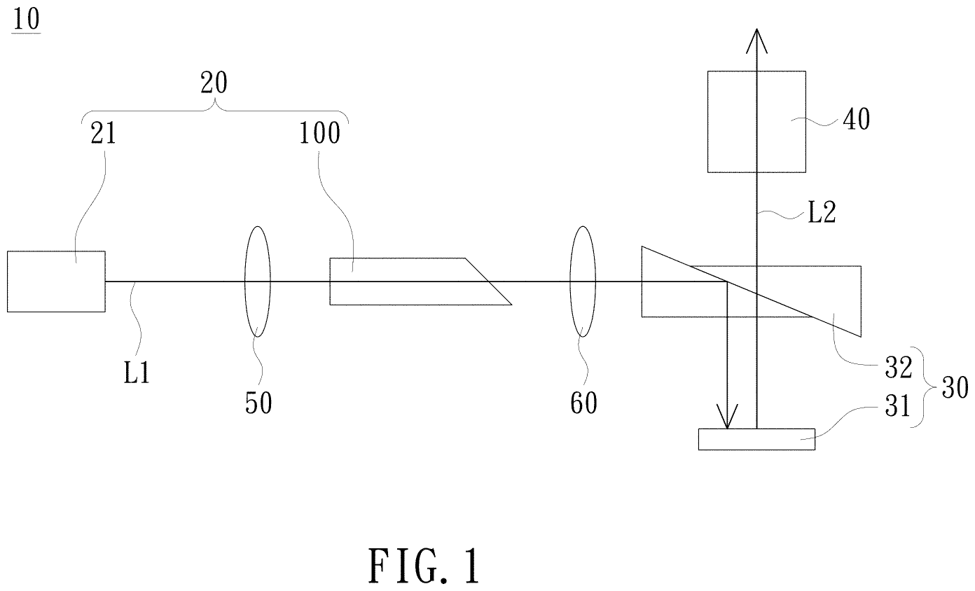

FIG. 1 is a schematic diagram of a projection device according to an embodiment of the invention. Please refer to FIG. 1. The projection device 10 of the embodiment includes an illumination system 20, an optical engine system 30, and a projection lens 40. The illumination system 20 includes a light source 21 and a light integration rod 100. The light source 21 is, for example, a gas discharge lamp, a laser source or a light emitting diode (LED) light source for providing an illumination beam L1 (converged illumination beam, for example). The illumination beam L1 converges into the light integration rod 100. The illumination beam L1 is then irradiated to the optical engine system 30 after the illumination beam L1 is uniformized by the light integration rod 100. The optical engine system 30 is disposed on a transmission path of the illumination beam L1 and is used to convert the illumination beam L1 (uniformized by the light integration rod 100) into an image beam L2. The projection lens 40 is disposed on a transmission path of the image beam L2 and is used to project the image beam L2 onto a screen (not shown) to form an image.

The optical engine system 30 includes, for example, a light valve 31 and a light guiding element 32. The light valve 31 is used to convert the illumination beam L1 into the image beam L2. The light valve 31 is, for example, a reflective light valve. The reflective light valve is, for example, a digital micro-mirror device (DMD) or a liquid-crystal-on-silicon (LCOS) panel, but is not limited thereto. The light guiding element 32 is, for example, a total internal reflection prism or a mirror for reflecting the illumination beam L1 to the light valve 31 and for transmitting the image beam L2 from the light valve 31 to the projection lens 40, but is not limited thereto.

The projection lens 40 includes, for example, a combination of one or more optical lenses having diopter, such as various combinations of non-planar lenses including biconcave lenses, biconvex lenses, concavo-convex lenses, convexo-concave lenses, plano-convex lenses, and plano-concave lenses. In an embodiment, the projection lens 40 may also include a planar optical lens. The invention does not limit the form and the type of the projection lens 40.

The projection device 10 may further include a plurality of lenses or other optical components, such as lenses 50, 60. The lens 50 is disposed between the light source 21 and the light integration rod 100. The lens 60 is disposed between the light integration rod 100 and the light guiding element 32 for focusing the illumination beam L1 from the light integration rod 100 to the light valve 31. Hereinafter, the detailed structure and embodiment of the light integration rod 100 of the projection device 10 will be further described.

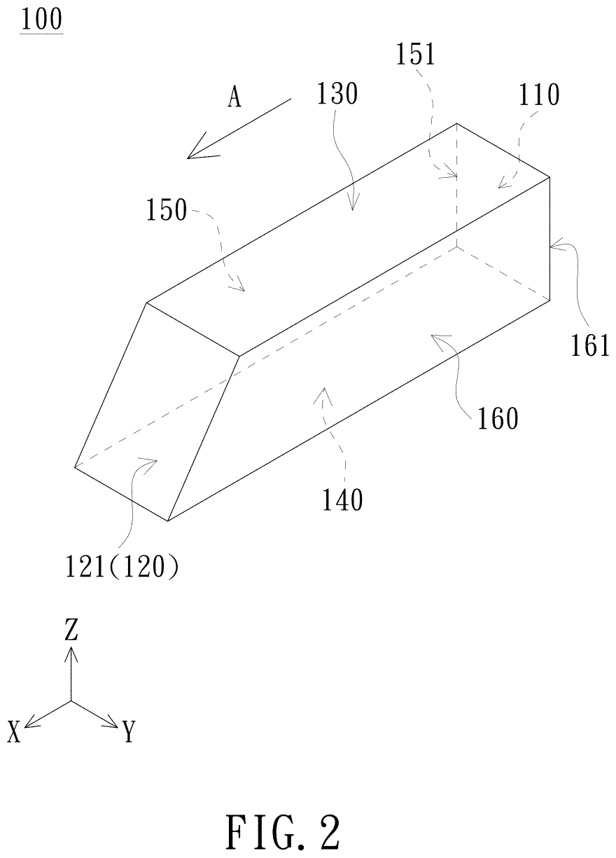

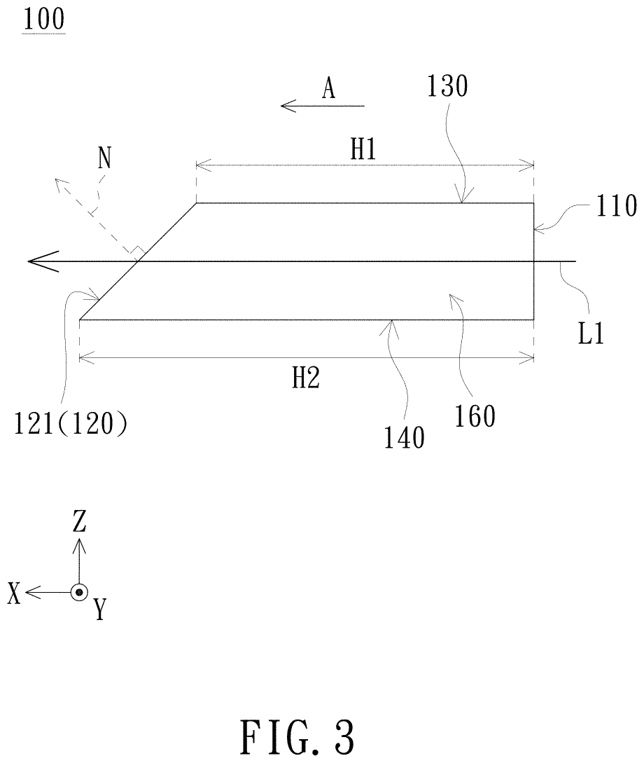

FIG. 2 is a schematic pictorial view of a light integration rod according to an embodiment of the invention. The hidden part is shown by the dashed lines and the elements of the hidden part are indicated by the dashed arrows. FIG. 3 is a schematic view of the light integration rod in the X-Z plane in FIG. 2. Please refer to FIG. 2 and FIG. 3. The light integration rod 100 according to the embodiment has a light incident end 110 and a light emitting end 120 opposite to each other. The illumination beam L1 exits the light integration rod 100 via the light emitting end 120 after the illumination beam L1 is incident on the light incident end 110 of the light integration rod 100. A normal vector N of a light emitting cross section 121 of the light emitting end 120 is non-parallel to a light emitting direction A of the light integration rod 100, wherein the light emitting direction A of the light integration rod 100 is the optical axis direction or the main light traveling direction of the light integration rod 100 (parallel to side surfaces of the light integration rod 100, for example). The light emitting cross section 121 is a plane through which the illumination beam L1 exits the light integration rod 100 from the light emitting end 120. The light integration rod 100 is, for example, a solid rod or a hollow rod that is transparent to light, which is made of glass, plastic or mirror. The light emitting cross section 121 of the light emitting end 120 is, for example, a light exit surface when the light integration rod 100 is a solid rod. The light emitting cross section 121 of the light emitting end 120 is, for example, an opening (formed by side surfaces of the light integration rod 100 at the light emitting end 120, for example) when the light integration rod 100 is a hollow rod. The light emitting direction A is a direction along which the illumination beam L1 is transmitted from the light emitting end 120 to the optical engine system 30, and is parallel to the optical axis of the light integration rod 100.

The light integration rod 100 is, for example, a square rod, but the invention does not particularly limit the shape of the rod for the light integration rod 100. The light integration rod 100 may also have a different rod shape such as can be a polygonal rod, a rod in which the light incident end is broad and the light emitting end is narrow (a projected area of the light incident end 110 is greater than a projected area of the light emitting end 120 on Y-Z plane, for example), or the light incident end is narrow and the light emitting end is broad (not shown). Please refer to FIG. 3. In the embodiment, the light integration rod 100 further has, for example, a first surface 130, a second surface 140, a third surface 150, and a fourth surface 160 located between the light incident end 110 and the light emitting end 120. The first surface 130 and the second surface 140 are opposite to each other. The third surface 150 and the fourth surface 160 are opposite to each other. The third surface 150 and the fourth surface 160 are connected between the first surface 130 and the second surface 140.

Specifically, a shape of the first surface 130 and a shape of the second surface 140 are, for example, rectangular, and a length H1 of the first surface 130 is less than a length H2 of the second surface 140, wherein the direction of which the lengths H1, H2 extend is, for example, parallel to the light emitting direction A. In an embodiment, a length difference between the length H1 of the first surface 130 and the length H2 of the second surface 140 is between 0.1 mm and 3 mm and preferably between 0.2 mm and 2 mm.

On the other hand, a shape of the third surface 150 and a shape of the fourth surface 160 are, for example, trapezoidal. The third surface 150 has a third side edge 151 at the light incident end 110. The fourth surface 160 has a fourth side edge 161 at the light incident end 110. The third side edge 151 and the fourth side edge 161 are perpendicular to the light emitting direction A.

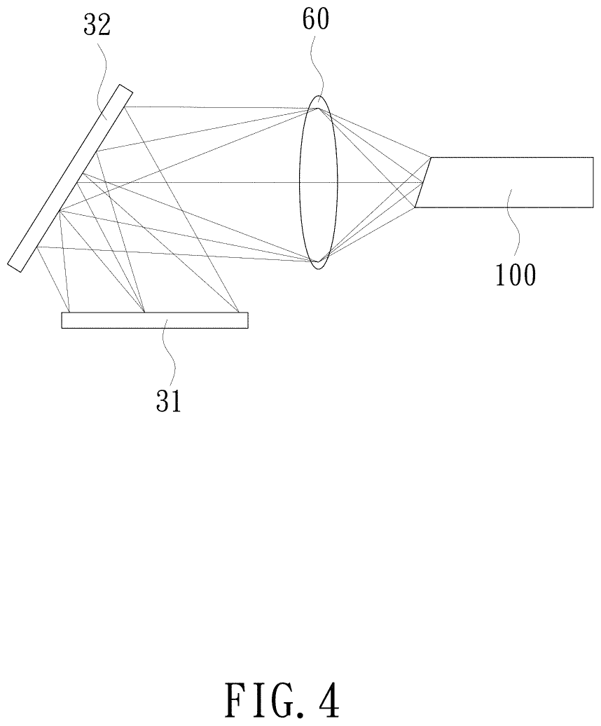

In the light integration rod 100 of the embodiment, by adjusting the length difference between the length H1 of the first surface 130 and the length H2 of the second surface 140, the normal vector N of the light emitting cross section 121 of the light emitting end 120 is non-parallel to the light emitting direction A of the light integration rod 100, and therefore, the illumination beam L1 can be completely compensated to irradiate at the focus position of each region of the light valve 31, and thereby reducing the defocusing phenomenon at the edge region of the light spot due to the optical path difference. For example, as shown in FIG. 4, which is a schematic diagram of beam paths of the illumination beam (only the function of the reflection part of the light guiding element 32 is shown). The illumination beam L1 from the light integration rod 100 is focused by the lens 60 and is reflected to the light valve 31 by the light guiding element 32, so that the illumination beam L1 can be focused as much as possible to each region of the light valve 31 (the focal plane of the illumination beam L1 falls substantially on the light valve 31) without the occurrence of defocusing phenomenon at the edge region of the light spot. The light integration rod 100 of the embodiment does not cause additional light loss, as compared with the known method of enlarging the end of the light integration rod to enlarge the illumination area of the beam irradiating on the light valve to overcome the disadvantage of defocusing phenomenon. Therefore, the light utilization efficiency of the light integration rod 100 of the embodiment is improved.

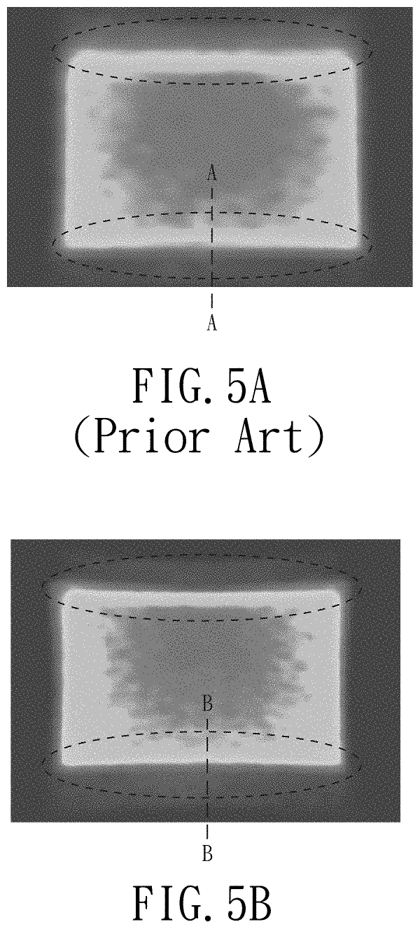

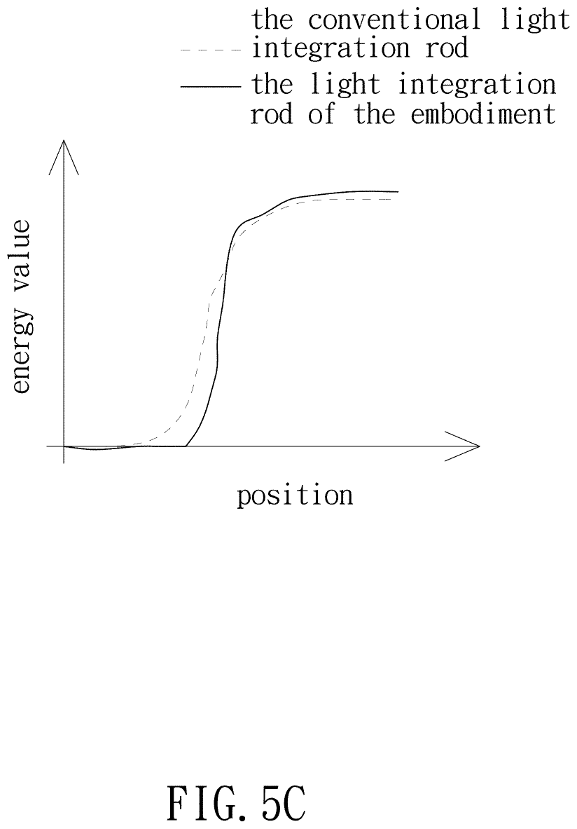

FIG. 5A is a schematic view of an energy distribution of a light spot on a light valve when a conventional light integration rod is used. FIG. 5B is a schematic view of an energy distribution of a light spot on a light valve when the light integration rod of the embodiment is used. FIG. 5C is a comparison diagram showing the energy distributions of the edge region of the light spots of FIG. 5A and FIG. 5B. Please refer to FIG. 5A first. In the case of the incident angle of the illumination beam L1 to the light valve 31 is increased (TRP technology, for example), the defocusing phenomenon is likely to occur at the edge of the light spot if the known light integration rod is used, that is, the edge of the light spot (the circles indicated by the dashed lines on the upper side and the lower side) is blurred (the energy at the edge is divergent). Please refer to FIG. 5B. If the light integration rod 100 of the embodiment is used and by adjusting the illumination beam L1 to irradiate on the focal plane of the light valve 31, it can be seen that the light spot in the circles indicated by the dashed lines on the upper side and the lower side are relatively clear and sharp (the energy at the edge is convergent). As a result, the defocusing phenomenon can be overcome without the need to enlarge the area of the light emitting end of the light integration rod to cause additional light loss. Please refer to FIG. 5C, in which the energy distribution of the edge region of the light spot on the light valve using the known light integration rod (taken along the line A-A in FIG. 5A) and the energy distribution of the edge region of the light spot on the light valve using the light integration rod of the embodiment (taken along the line B-B in FIG. 5B) are compared. The energy distribution of the edge region of the light spot of the light integration rod of the embodiment is more constricted (convergent) compared with that of the known light integration rod, so that the efficiency of using the illumination beam is improved.

With the brightness of the image beam L2 projected out the projection device 10 in FIG. 1 as a standard, since the illumination beam L1 is more focused on the light valve 31, the light integration rod 100 of the embodiment can make the light utilization efficiency increase at least by 4% compared with the known light integration rod.

In summary, in the light integration rod of the embodiment of the invention, the illumination beam is adjusted to enter the focal plane of the light valve by making the normal vector of the light emitting cross section of the light emitting end non-parallel to the light emitting direction of the light integration rod, thereby reducing the defocus phenomenon. The light integration rod of the invention does not cause additional light loss compared with the known method of enlarging the end of the light integration rod to overcome the defocusing phenomenon, thereby improving light utilization efficiency.

The foregoing description of the preferred embodiment of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like is not necessary limited the claim scope to a specific embodiment, and the reference to particularly preferred exemplary embodiments of the invention does not imply a limitation on the invention, and no such limitation is to be inferred. The invention is limited only by the spirit and scope of the appended claims. Moreover, these claims may refer to use “first”, “second”, etc. following with noun or element. Such terms should be understood as a nomenclature and should not be construed as giving the limitation on the number of the elements modified by such nomenclature unless specific number has been given. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the invention as defined by the following claims. Moreover, no element and component in the disclosure is intended to be dedicated to the public regardless of whether the element or component is explicitly recited in the following claims. Furthermore, the terms such as the first surface, the second surface, the third surface, the third side edge, the fourth surface and the fourth side edge are only used for distinguishing various elements and do not limit the number of the elements.

What is claimed is:

1. A light integration rod, having a light incident end and a light emitting end opposite to each other, wherein a normal vector of a light emitting cross section of the light emitting end is non-parallel to a light emitting direction of the light integration rod.

2. The light integration rod according to claim 1, further having a first surface, a second surface, a third surface and a fourth surface located between the light incident end and the light emitting end, wherein the first surface and the second surface are opposite to each other, the third surface and the fourth surface are opposite to each other, and the third surface and the fourth surface are connected between the first surface and the second surface.

3. The light integration rod according to claim 2, wherein a shape of the first surface and a shape of the second surface are rectangular, a length of the first surface is less than a length of the second surface, and a difference between the length of the first surface and the length of the second surface is between 0.1 mm and 3 mm.

4. The light integration rod according to claim 2, wherein a shape of the third surface and a shape of the fourth surface are trapezoidal, the third surface has a third side edge at the light incident end, the fourth surface has a fourth side edge at the light incident end, and the third side edge and the fourth side edge are perpendicular to the light emitting direction.

5. The light integration rod according to claim 1, wherein the light integration rod is a hollow rod, and the light emitting end is an opening.

6. The light integration rod according to claim 1, wherein the light integration rod is a solid rod, and the light emitting end is a light emitting surface.

7. A projection device, comprising an illumination system, a light guiding element, a light valve and a projection lens, wherein:
the illumination system comprises a light source and a light integration rod, the light source is used to provide an illumination beam passing through the light integration rod, the light integration rod has a light incident end and a light emitting end opposite to each other, and a normal vector of a light emitting cross section of the light emitting end is non-parallel to a light emitting direction of the light integration rod;
the light guiding element is disposed on a transmission path of the illumination beam and is used to receive the illumination beam from the light integration rod;
the light valve is disposed on the transmission path of the illumination beam and is used to receive the illumination beam from the light guiding element and convert the illumination beam into an image beam; and
the projection lens is disposed on a transmission path of the image beam and is used to project the image beam out of the projection device.

8. The projection device according to claim 7, further having a first surface, a second surface, a third surface and a fourth surface located between the light incident end and the light emitting end, wherein the first surface and the second surface are opposite to each other, the third surface and the fourth surface are opposite to each other, and the third surface and the fourth surface are connected between the first surface and the second surface.

9. The projection device according to claim 8, wherein a shape of the first surface and a shape of the second surface are rectangular, a length of the first surface is less than a length of the second surface, and a difference between the length of the first surface and the length of the second surface is between 0.1 mm and 3 mm.

10. The projection device according to claim 8, wherein a shape of the third surface and a shape of the fourth surface are trapezoidal, the third surface has a third side edge at the light incident end, the fourth surface has a fourth side edge at the light incident end, and the third side edge and the fourth side edge are perpendicular to the light emitting direction.

11. The projection device according to claim 7, wherein the light integration rod is a hollow rod, and the light emitting end is an opening.

12. The projection device according to claim 7, wherein the light integration rod is a solid rod, and the light emitting end is a light emitting surface.

13. The projection device according to claim 7, wherein the light source comprises a gas discharge lamp, a laser source or a light emitting diode light source.
